(19) United States
(12) Patent Application Publication
(10) Pub. No.: US 2022/0366407 A1
(43) Pub. Date: Nov. 17, 2022

(54) METHOD AND SYSTEM FOR PRIVACY ORIENTED PROVENANCE AT THE POINT OF SALE

(71) Applicant: MASTERCARD INTERNATIONAL INCORPORATED, Purchase, NY (US)

(72) Inventors: Robert COLLINS, Blackrock (IE); Steven C. DAVIS, Saint Peters, MO (US); Rob BYRNE, Wicklow (IE); Peter J. GROARKE, Dublin 18 (IE)

(73) Assignee: MASTERCARD INTERNATIONAL INCORPORATED, Purchase, NY (US)

(21) Appl. No.: 17/319,532

(22) Filed: May 13, 2021

(51) Int. Cl. G06Q 20/38; G06Q 20/40; G06Q 20/20

(52) U.S. Cl. CPC G06Q 20/3827; G06Q 20/4014; G06Q 20/204

(57) ABSTRACT

The present disclosure provides a description of systems and methods for verifying product authenticity at a point of sale through transaction messages. A point of sale may collect product identifiers from products that a consumer is interested in purchase as part of a traditional checkout process. Product identifiers can be included in special data elements in a transaction message that is submitted to a merchant's acquiring bank through for the payment transaction. As part of the processing of the transaction by the acquirer, the acquirer can consult a processor to check the authenticity of the products being purchased by examining a provenance blockchain for the product identifiers included in the transaction message. If the products are determined to be authentic, the transaction can proceed as normal. If the products are not authentic, then the acquirer can deny the transaction and stop the consumer from purchasing a counterfeit or fraudulent good.

### FIELD

The present disclosure relates to privacy-oriented provenance at point of sale, specifically the use of a blockchain to track item provenance to enable a verification of the authenticity of a product at a point of sale through transaction messages.

### BACKGROUND

Blockchain was initially created as a storage mechanism for use in conducting payment transactions with a cryptographic currency. Using a blockchain provides a number of benefits, such as decentralization, distributed computing, transparency regarding transactions, and yet also providing anonymity as to the individuals or entities involved in a transaction. One of the more popular aspects of a blockchain is that it is an immutable record: every transaction ever that is part of the chain is stored therein and cannot be changed due to the computational requirements and bandwidth limitations, particularly as a chain gets longer and a blockchain network adds more nodes.

Because blockchains store an immutable record for any manner of data, some blockchains have been developed to store information regarding the provenance of items, such as tracking the production and distribution of perishable goods or high value items. For example, a blockchain may be used to track produce, where an entry may be created when the produce is harvested, picked up from the harvesting location, dropped off at a distributor, loaded into a truck by the distributor, arrived at a retailer, accepted by the retailer, and sold to a consumer. These entries may, as a result, store the lifecycle of genuine products.

However, consumers may have no ability to access a provenance blockchain, to identify a desired item on such a blockchain, or be able to understand the data being stored therein. At the same time, consumers may have a significant interest in ensuring that a product they desire for purchase is authentic, such as a consumer interested in medication or an expensive luxury item. Thus, there is a need for a system that enables consumers to verify the authenticity of a product for purchase, which can leverage a provenance blockchain.

### SUMMARY

The present disclosure provides a description of systems and methods for verifying product authenticity at a point of sale through transaction messages. A point of sale may collect product identifiers from products that a consumer is interested in purchase as part of the traditional checkout process. The product identifiers can be included in special data elements in a transaction message that is submitted to a merchant's acquiring bank through for the payment transaction. As part of the processing of the transaction by the acquirer, the acquirer can consult a processor to check the authenticity of the products being purchased by examining a provenance blockchain for the product identifiers included in the transaction message. If the products are determined to be authentic, the transaction can proceed as normal. If the products are not authentic, then the acquirer can deny the transaction and stop the consumer from purchasing a counterfeit or fraudulent good. The consumer may also be notified of the inauthenticity of one or more of the products through the point of sale, which can reassure the consumer of other products being purchased, or enable the consumer to leave and select another merchant. By using standard transaction messages, the consumer experience can remain the same and existing communication paths and processes can be utilized while still providing this additional service to the benefit of consumers, merchants, and manufacturers alike.

A method for verifying product authenticity at a point of sale through transaction messages includes: receiving, by a point of sale device, one or more product identification values, each product identification value corresponding to a product being purchased in a payment transaction; generating, by the point of sale device, a transaction message including one or more data elements storing the one or more product identification values, where the transaction message is formatted according to one or more standards; transmitting, by the point of sale device, the transaction message to a first processing system; transmitting, by the first processing system, the one or more product identification values parsed from the one or more data elements included in the received transaction message to a second processing system; receiving, by the first processing system, a verification result for each of the one or more product identification values from the second processing system; and processing, by the first processing system, the payment transaction, wherein processing includes (i) transmitting a response message to the point of sale device denying the payment transaction if the verification result for at least one of the one or more product identification values indicates a failed verification, or (ii) transmitting the transaction message to a payment network if the verification result for each of the one or more product identification values indicates a successful verification.

A system for verifying product authenticity at a point of sale through transaction messages includes: a point of sale device; a first processing system; and a second processing system, wherein the point of sale device receives one or more product identification values, each product identification value corresponding to a product being purchased in a payment transaction, generates a transaction message including one or more data elements storing the one or more product identification values, where the transaction message is formatted according to one or more standards, and transmits the transaction message to the first processing system, and the first processing system transmits the one or more product identification values parsed from the one or more data elements included in the received transaction message to the second processing system; receives a verification result for each of the one or more product identification values from the second processing system, and processes the payment transaction, wherein processing includes (i) transmitting a response message to the point of sale device denying the payment transaction if the verification result for at least one of the one or more product identification values indicates a failed verification, or (ii) transmitting the transaction message to a payment network if the verification result for each of the one or more product identification values indicates a successful verification.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture verifying product authenticity at a point of sale through transaction messages in accordance with exemplary embodiments.

FIG. 2 is a block diagram illustrating a computing system of the system of FIG. 1 for use in verifying product authenticity in a payment transaction in accordance with exemplary embodiments.

FIGS. 3A and 3B are a flow diagram illustrating a process for verifying product authenticity at a point of sale through transaction messages and a provenance blockchain in accordance with exemplary embodiments.

FIG. 4 is a flow chart illustrating an exemplary method for verifying product authenticity at a point of sale through transaction messages in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Blockchain—A public ledger of all transactions of a blockchain-based currency. One or more computing devices may comprise a blockchain network, which may be configured to process and record transactions as part of a block in the blockchain. Once a block is completed, the block is added to the blockchain and the transaction record thereby updated. In many instances, the blockchain may be a ledger of transactions in chronological order, or may be presented in any other order that may be suitable for use by the blockchain network. In some configurations, transactions recorded in the blockchain may include a destination address and a currency amount, such that the blockchain records how much currency is attributable to a specific address. In some instances, the transactions are financial and others not financial, or might include additional or different information, such as a source address, timestamp, etc. In some embodiments, a blockchain may also or alternatively include nearly any type of data as a form of transaction that is or needs to be placed in a distributed database that maintains a continuously growing list of data records hardened against tampering and revision, even by its operators, and may be confirmed and validated by the blockchain network through proof of work and/or any other suitable verification techniques associated therewith. In some cases, data regarding a given transaction may further include additional data that is not directly part of the transaction appended to transaction data. In some instances, the inclusion of such data in a blockchain may constitute a transaction. In such instances, a blockchain may not be directly associated with a specific digital, virtual, fiat, or other type of currency.

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by Mastercard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Verifying Product Authenticity at Point of Sale

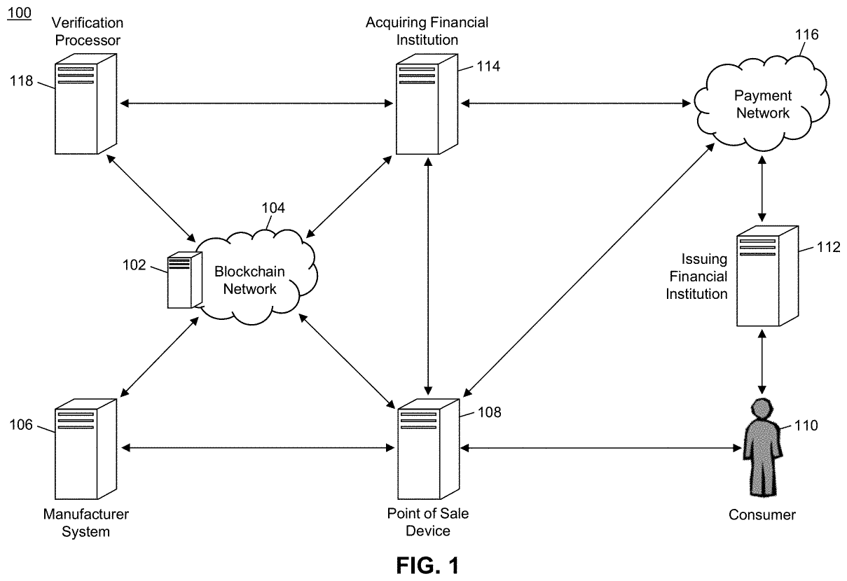

FIG. 1 illustrates a system 100 for verifying the authenticity of products at a point of sale through the use of a provenance blockchain and traditional transaction messaging.

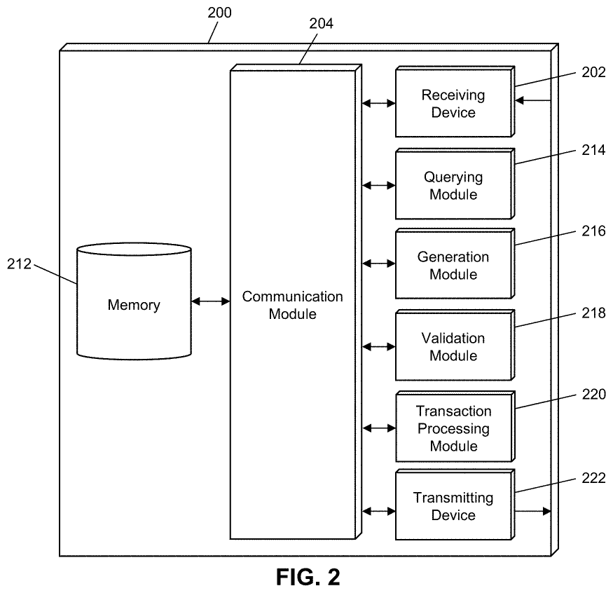

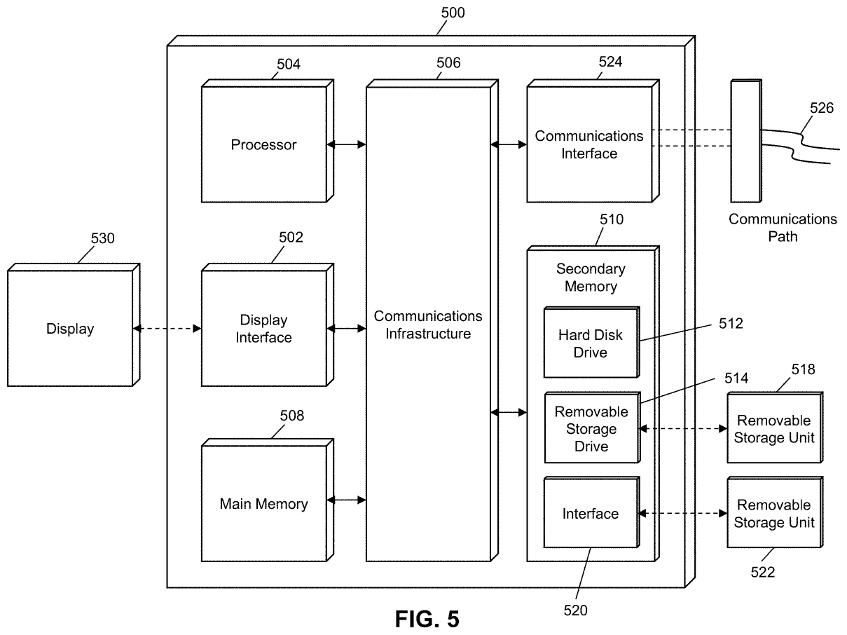

The system 100 may include one or more blockchain nodes 102. Each blockchain node 102 may be part of a blockchain network 104. Each blockchain node 102 may be a computing system, such as illustrated in FIGS. 2 and 5, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain.

The blockchain may be a distributed ledger that is comprised of at least a plurality of blocks. Each block may include at least a block header and one or more data values. Each block header may include at least a timestamp, a block reference value, and a data reference value. The timestamp may be a time at which the block header was generated, and may be represented using any suitable method (e.g., UNIX timestamp, DateTime, etc.). The block reference value may be a value that references an earlier block (e.g., based on timestamp) in the blockchain. In some embodiments, a block reference value in a block header may be a reference to the block header of the most recently added block prior to the respective block. In an exemplary embodiment, the block reference value may be a hash value generated via the hashing of the block header of the most recently added block. The data reference value may similarly be a reference to the one or more data values stored in the block that includes the block header. In an exemplary embodiment, the data reference value may be a hash value generated via the hashing of the one or more data values. For instance, the block reference value may be the root of a Merkle tree generated using the one or more data values.

The use of the block reference value and data reference value in each block header may result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single blockchain node 102 in the blockchain network 104 prior to the generation and addition of a new block to the blockchain in order for the change to be made permanent. Computational and communication limitations may make such a modification exceedingly difficult, if not impossible, thus rendering the blockchain immutable.

In some embodiments, the blockchain may be used to store information regarding blockchain transactions conducted between two different blockchain wallets. A blockchain wallet may include a private key of a cryptographic key pair that is used to generate digital signatures that serve as authorization by a payer for a blockchain transaction, where the digital signature can be verified by the blockchain network 104 using the public key of the cryptographic key pair. In some cases, the term “blockchain wallet” may refer specifically to the private key. In other cases, the term “blockchain wallet” may refer to a computing device (e.g., manufacturer system 106, point of sale device 108, acquiring financial institution 114, verification processor 118, etc.) that stores the private key for use thereof in blockchain transactions. For instance, each computing device may each have their own private key for respective cryptographic key pairs, and may each be a blockchain wallet for use in transactions with the blockchain associated with the blockchain network. Computing devices may be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain may correspond to a blockchain transaction or other storage of data, as applicable. A blockchain transaction may consist of at least: a digital signature of the sender of that is generated using the sender's private key, a blockchain address of the recipient of currency generated using the recipient's public key, and a blockchain currency amount that is transferred or other data being stored. In the case of the blockchain being used for data storage separate from currency, the currency amount may be replaced by or added to such other data In some blockchain transactions, the transaction may also include one or more blockchain addresses of the sender where blockchain currency is currently stored (e.g., where the digital signature proves their access to such currency), as well as an address generated using the sender's public key for any change that is to be retained by the sender. Addresses to which cryptographic currency has been sent that can be used in future transactions are referred to as “output” addresses, as each address was previously used to capture output of a prior blockchain transaction, also referred to as “unspent transactions,” due to there being currency sent to the address in a prior transaction where that currency is still unspent. In some cases, a blockchain transaction may also include the sender's public key, for use by an entity in validating the transaction. For the traditional processing of a blockchain transaction, such data may be provided to a blockchain node 102 in the blockchain network 104, either by the sender or the recipient. The node may verify the digital signature using the public key in the cryptographic key pair of the sender's wallet and also verify the sender's access to the funds (e.g., that the unspent transactions have not yet been spent and were sent to address associated with the sender's wallet), a process known as “confirmation” of a transaction, and then include the blockchain transaction in a new block. The new block may be validated by other nodes in the blockchain network 104 before being added to the blockchain and distributed to all of the blockchain nodes 102 in the blockchain network 104 in traditional blockchain implementations. In cases where a blockchain data value may not be related to a blockchain transaction, but instead the storage of other types of data, blockchain data values may still include or otherwise involve the validation of a digital signature.

In the system 100, the blockchain network 104 may operate and store a provenance blockchain. A provenance blockchain may be a blockchain that stores data regarding a supply chain, where events in the supply chain are stored therein. Such events may include, for instance, product manufacture, pickup by a distribution entity, transportation from one storage facility to another, delivery to a retailer, sale by the retailer, resale by a consumer, addition of a product to a grouping of products, separation of a product from a grouping of products, chargeback of a product, etc. In some cases, a blockchain data value stored in the provenance blockchain for such an event may include detailed information about the event. In other cases, the blockchain data value may include a hash value of detailed information about the event, where the detailed information may be stored in a separate data storage. In some instances, documents and other data may be stored in the blockchain data values, such as directly or via hash values that can be used to verify the underlying data (e.g., an executed contract) that may be stored elsewhere, such as possessed by the entities involved in the executed contract. Additional information regarding the use and operation of provenance blockchains can be found in U.S. patent application Ser. No. 16/875,154, entitled “Method and System for Generalized Provenance Solution for Blockchain Supply Chain Applications,” by Steven C. Davis et al., filed May, 15, 2020, which is herein incorporated by reference in its entirety.

In the system 100, a consumer 110 may be interested in having the authenticity of a product being purchased prior to buying the product. When a product is manufactured, the manufacturer system 106 may assign a product identifier to the product. In some cases, the product identifier may be unique to the product, such as a serial number that is unique across all of the products that are manufactured. In other cases, the product identifier may be assigned to all products of a common set, such as a lot number assigned to a set of medication, where each item in the set may be considered the same for tracking purposes. The product identifier may be any suitable type of value of a suitable length, such as an integer or alphanumeric value. The manufactured product may be stored on the provenance blockchain, where the creation of the product may be stored in a corresponding entry in the blockchain.

The product may be stored in the provenance blockchain via a hash of the product identifier. A hashing algorithm may be applied to the product identifier, which may result in a hash value that is stored in the provenance blockchain. The hashing algorithm may ensure that the product can be tracked, without revealing the underlying product identifier if a one-way hashing algorithm is used, such as to prevent a nefarious actor from labeling a counterfeit product with the serial number or other product identifier of a genuine product. In an exemplary embodiment, the hashing algorithm may be a one-way, collision-resistant hashing algorithm. In some cases, manufacturer systems 106 may be encouraged to use non-sequential serial numbers and other product identifiers as an additional measure against counterfeit.

The distribution of the product may be tracked using the provenance blockchain, as discussed above. The product may eventually be delivered to a merchant for purchase by the consumer 110. When the merchant receives the product, a new entry may be entered into the blockchain that includes the hashed product identifier and an indication of accepted delivery by the merchant.

In the system 100, the consumer 110 may be issued a transaction account that is to be used for paying for the desired product. An issuing financial institution, such as an issuing bank, may issue a transaction account to the consumer 110 and, as part of the issuing of the transaction account, may issue a payment card, such as a credit card or debit card, or other payment instrument to the consumer 110 for use in conveying account details to enable a payment transaction to be processed that is funded via the consumer's issued transaction account.

When the consumer 110 is interested in purchasing the desired product, the consumer 110 may select the product and approach a point of sale device 108 to conduct a payment transaction and begin a checkout process. As part of the checkout process, the point of sale device 108 may collect a product identifier for each product being purchased for which authenticity is to be verified. In some cases, the consumer 110 may indicate which product(s) for which they would like the authenticity to be verified. In other cases, the merchant may have rules regarding which products being sold are to have the authenticity verified, such as any product that is tracked via a provenance blockchain, or products above a predetermined price point. The point of sale device 108 may collect product identifiers using any suitable method, such as the reading of a machine-readable code with an optical imaging device, receipt of the product identifier via electronic transmission, such as through near field communication or radio frequency, entry of the product identifier via an input device by an employee of the merchant or the consumer 110, etc. In some cases, the received product identifier may be the hashed product identifier. In other cases, the point of sale device 108 may hash the product identifier upon receipt to generate the hashed product identifier.

The point of sale device 108 may also collect any other information necessary for the processing of a payment transaction for purchase of the product(s) to be verified and any other products. Such information may include transaction account information for the consumer's transaction account to be used to fund the payment transaction (e.g., read or received from the payment instrument, such as via the reading of a magnetic stripe, receipt of a near field communication transmission, etc.), a transaction amount, point of sale identifier, currency type, transaction time, transaction date, merchant identifier, merchant category code, loyalty data, reward data, coupon data, etc.

In order to initiate the processing of a payment transaction to facilitate payment by the consumer 110 for the selected product(s), the point of sale device 108 may generate a transaction message. A transaction message may be a specially formatted data message that is formatted pursuant to one or more standards governing the interchange of financial transaction messages, such as the International Organization of Standardization's ISO 8583 or ISO 20022 standards. A transaction message may include a plurality of data elements, where each data element stores data as indicated in the applicable standard(s). In some cases, the transaction message may include one or more bitmaps, which may indicate the data stored in each data element in the transaction message. Each transaction message may also include a message type indicator, which may indicate a type for the transaction message for use in the processing of the transaction message.

A traditional transaction message may store data necessary for use in the standard processing of a payment transaction in predefined data elements, such as the storage of a transaction amount, transaction account data for the consumer's transaction account used to fund the payment transaction, transaction account data for a transaction account of the merchant used to receive the funds in the payment transaction, and the above transaction data, such as the transaction time, transaction date, point of sale identifier, currency type, transaction time, transaction date, merchant identifier, merchant category code, loyalty data, reward data, coupon data, etc. In the system 100, the transaction message may also stored the hashed product identifier for each product for which authenticity is to be verified. In some cases, the hashed product identifiers may all be stored in a single data element. In other cases, the hashed product identifiers may each be stored in their own data element in instances where multiple products are to have their authenticity verified. In some instances, a transaction message may require an additional bitmap for the definition of additional data elements for use in storing hashed product identifiers, such as if the number of products being verified exceeds a predetermined number. In some embodiments, the data elements used to store hashed product identifiers may be data elements reserved for private use according to the applicable standard(s).

The point of sale device 108 may electronically transmit the transaction message to an acquiring financial institution 114 using a suitable communication network and method. In some cases, the point of sale device 108 may electronically transmit the transaction message directly to the acquiring financial institution 114. In other cases, the point of sale device 108 may electronically transmit the transaction message to the acquiring financial institution 114 via one or more intermediaries, such as through a payment network 116. In some instances, the transaction message may be electronically transmitted to the acquiring financial institution 114 via payment rails associated with the payment network 116, either directly by the point of sale device 108 or through the payment network 116. In some embodiments, the communication network and method may be specially configured for the transmission of specially formatted transaction messages. The acquiring financial institution 114 may be a financial institution, such as an acquiring bank, or other entity that issues a transaction account to the merchant for use in receiving the funds in electronic payment transactions involving the merchant.

The acquiring financial institution 114 may receive the transaction message and may identify that one or more product verifications are to be performed. Such an identification may be based on the storage of one or more hashed product identifiers in the predetermined data elements, the inclusion of a specific bitmap or bitmap data in the transaction message, or other indication, such as a data flag stored in a predetermined data element that may indicate that product authenticity verification is requested or indicate the number of product verifications to be performed. If no product verifications are to be performed, the transaction message may be processed using traditional methods.

To perform the verification of the authenticity of a product being purchased by the consumer 110, the acquiring financial institution 114 may parse the hashed product identifiers from the transaction message. A verification process may then be performed using the hashed product identifiers. In some embodiments, the acquiring financial institution 114 may perform the verification process. In other embodiments, the verification process may be performed by a verification processor 118, which may be a third party computing system and/or entity separate from the acquiring financial institution 114. In embodiments where the verification processor 118 performs the verification process, the acquiring financial institution 114 may electronically transmit the parsed, hashed product identifier(s) to the verification processor 118 using any suitable communication network and method. For example, the verification processor 118 may utilize an application programming interface for the submission of hashed product identifiers for verifying product authenticity.

The verification process may include examination of the provenance blockchain to identify inclusion of the hashed product identifier. The verification processor 118 (e.g., or acquiring financial institution 114, as applicable) may identify all blockchain data entries included in the provenance blockchain that include the hashed product identifier. The verification processor 118 may then verify that the product has passed through proper chain of custody from the manufacturer to the merchant, such as by verifying that the provenance blockchain includes an initial entry from the manufacturer, and proper delivery and acceptance by any distributing entities, followed by receipt of the product by the merchant associated with the point of sale device 108. If there are no blockchain data entries that include the hashed product identifier, or if the chain of custody of the product cannot be successfully verified (e.g., the merchant has accepted possession of the product but the manufacturer has not yet registered pickup of the product by a distributor), then the verification of the authenticity of the product may fail. Otherwise, the verification may be successful, and the product may be determined to be authentic and genuine. In cases where the acquiring financial institution 114 does not perform the verification process, the entity performing the verification process (e.g., the verification processor 118) may return a verification result for each hashed product identifier to the acquiring financial institution using the appropriate communication method.

The acquiring financial institution 114 may accordingly have a verification result for each hashed product identifier. In cases where every verification is successful (e.g., all of the products being purchased are authentic and genuine), the acquiring financial institution 114 may continue with the processing of the payment transaction using traditional systems and methods. If one or more verifications fail, the acquiring financial institution 114 may deny the payment transaction, such as by returning an authorization response transaction message to the point of sale device 108 that includes a response code indicating denial of the payment transaction. In some cases, the response code may indicate denial because of unsuccessful verification of the authenticity of one or more products. In some instances, the authorization response message may indicate the product or products for which authentication failed, such as by storing the hashed product identifier for each failed verification in a predetermined data element or elements. In some further instances, a reason for the failed verification may be further indicated, such as indicating that the hashed product identifier was not found, chain of custody not verified, etc.

In some embodiments, the point of sale device 108 may display a notification to the consumer 110 via a display device thereof information regarding the unsuccessful verification(s). For example, the point of sale device 108 may convey which product(s) were not successfully verified, and may provide the consumer 110 with the opportunity to still purchase the product(s) or to continue with the transaction without the product(s) whose authenticity verification failed. In such instances, the point of sale device 108 may submit another transaction message to the acquiring financial institution 114 for processing of the payment transaction for the products selected by the consumer 110 after viewing the notification. In cases where the consumer 110 does not wish to continue with the payment transaction, the payment transaction may be canceled and the consumer 110 may leave without purchasing the unsuccessfully verified product(s). If the payment transaction is successfully processed, then the consumer 110 may be provided with the purchased product(s).

The systems and methods discussed herein enable the verification of the authenticity of products at point of sale. When a consumer 110 wants to purchase a product whose provenance is stored in a provenance blockchain, the authenticity of the product may be verified as part of the processing of the payment transaction. By conveying the hashed product identifiers in the transaction messages, the verification may be performed using existing communication methods and technologies, which may enable the verification to be performed using existing point of sale systems and financial institution systems. In addition, no actions need to be performed by the consumer 110, which enable the consumer 110 to be assured of the authenticity of products being purchased without having to perform any actions outside of the standard transaction process. As a result, the methods and systems discussed herein provide for valuable services to consumers 110 and merchants, ensuring that counterfeit products are not sold, without affecting the consumer experience, and relying on existing technologies and processes. Such a process may be additionally valuable in cases of health and safety, such as to prevent the sale of counterfeit medication, to enable a consumer 110 to be sure the medication they are purchasing is genuine.

### Computing System

FIG. 2 illustrates an embodiment of a computing system 200 in the system 100. It will be apparent to persons having skill in the relevant art that the embodiment of the computing system 200 illustrated in FIG. 2 is provided as illustration only and may not be exhaustive to all possible configurations of the computing system 200 suitable for performing the functions as discussed herein. For example, the computer system 500 illustrated in FIG. 5 and discussed in more detail below may be a suitable configuration of the computing system 200. Blockchain nodes 102, point of sale devices 108, acquiring financial institutions 114, and verification processors 118 in the system 100 of FIG. 1 may be implemented as the computing system 200 (e.g., or computer system 500) and include one or more of the components as illustrated in FIG. 2 or discussed below.

The computing system 200 may include a receiving device 202. The receiving device 202 may be configured to receive data over one or more networks via one or more network protocols. In some instances, the receiving device 202 may be configured to receive data from other blockchain nodes 102, manufacturer systems 106, point of sale devices 108, issuing financial institutions 112, acquiring financial institutions 114, payment networks 116, verification processors 118, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by point of sale devices 108, acquiring financial institutions 114, or payment networks 116 that may be superimposed or otherwise encoded with transaction messages. The receiving device 202 may be configured to receive data signals electronically transmitted by acquiring financial institutions 114 that are superimposed or otherwise encoded with hashed product identifiers, verification results, or notification data. The receiving device 202 may also be configured to receive data signals electronically transmitted by verification processors 118, which may be superimposed or otherwise encoded with verification results.

The computing system 200 may also include a communication module 204. The communication module 204 may be configured to transmit data between modules, engines, databases, memories, and other components of the computing system 200 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the computing system 200 and external components of the computing system 200, such as externally connected databases, display devices, input devices, etc. The computing system 200 may also include a processing device. The processing device may be configured to perform the functions of the computing system 200 discussed herein as will be apparent to persons having skill in the relevant art. In some embodiments, the processing device may include and/or be comprised of a plurality of engines and/or modules specially configured to perform one or more functions of the processing device, such as a querying module 214, generation module 216, validation module 218, transaction processing module 220, etc. As used herein, the term “module” may be software or hardware particularly programmed to receive an input, perform one or more processes using the input, and provides an output. The input, output, and processes performed by various modules will be apparent to one skilled in the art based upon the present disclosure.

The computing system 200 may include a memory 212. The memory 212 may be configured to store data for use by the computing system 200 in performing the functions discussed herein. The memory 212 may be configured to store data using suitable data formatting methods and schema and may be any suitable type of memory, such as read-only memory, random access memory, etc. The memory 212 may include, for example, encryption keys and algorithms, communication protocols and standards, data formatting standards and protocols, program code for modules and application programs of the processing device, and other data that may be suitable for use by the computing system 200 in the performance of the functions disclosed herein as will be apparent to persons having skill in the relevant art. In some embodiments, the memory 212 may be comprised of or may otherwise include a relational database that utilizes structured query language for the storage, identification, modifying, updating, accessing, etc. of structured data sets stored therein. The memory 212 may be configured to store, for example, transaction data, blockchain data, communication data, transaction message formatting standards, hashing algorithms, etc.

The computing system 200 may include a querying module 214. The querying module 214 may be configured to execute queries on databases to identify information. The querying module 214 may receive one or more data values or query strings, and may execute a query string based thereon on an indicated database, such as the memory 212 of the computing system 200 to identify information stored therein. The querying module 214 may then output the identified information to an appropriate engine or module of the computing system 200 as necessary. The querying module 214 may, for example, execute a query on the memory 212 to identify a hashing algorithm for hashing a product identifier, to identify transaction data for generating a transaction message, to identify blockchain data for a verification process, etc.

The computing system 200 may also include a generation module 216. The generation module 216 may be configured to generate data for use by the computing system 200 in performing the functions discussed herein. The generation module 216 may receive instructions as input, may generate data based on the instructions, and may output the generated data to one or more modules of the computing system 200. For example, the generation module 216 may be configured to generate hashed product identifiers via applying a hashing algorithm to a received product identifier.

The computing system 200 may also include a validation module 218. The validation module 218 may be configured to perform validations for the computing system 200 as part of the functions discussed herein. The validation module 218 may receive instructions as input, which may also include data to be used in performing a validation, may perform a validation as requested, and may output a result of the validation to another module or engine of the computing system 200. The validation module 218 may, for example, be configured to perform a verification process to verify the authenticity of a product via identify blockchain data values in a provenance blockchain that include a supplied hashed product identifier and review of the blockchain data values to ensure proper chain of custody of the corresponding product.

The computing system 200 may also include a transaction processing module 220. The transaction processing module 220 may be configured to perform functions for the computing system 200 for the initiation and processing of electronic payment transactions. The transaction processing module 220 may receive transaction account information and other transaction data as input and may output transaction messages or instructions to other modules or engines of the computing system 200. The transaction processing module 220 may be configured to, for example, generate transaction messages that are formatted pursuant to one or more applicable standards, which may include transaction data as well as hashed product identifiers stored in predetermined data elements.

The computing system 200 may also include a transmitting device 222. The transmitting device 222 may be configured to transmit data over one or more networks via one or more network protocols. In some instances, the transmitting device 222 may be configured to transmit data to other blockchain nodes 102, manufacturer systems 106, point of sale devices 108, issuing financial institutions 112, acquiring financial institutions 114, payment networks 116, verification processors 118, and other entities via one or more communication methods, local area networks, wireless area networks, cellular communication, Bluetooth, radio frequency, the Internet, etc. In some embodiments, the transmitting device 222 may be comprised of multiple devices, such as different transmitting devices for transmitting data over different networks, such as a first transmitting device for transmitting data over a local area network and a second transmitting device for transmitting data via the Internet. The transmitting device 222 may electronically transmit data signals that have data superimposed that may be parsed by a receiving computing device. In some instances, the transmitting device 222 may include one or more modules for superimposing, encoding, or otherwise formatting data into data signals suitable for transmission.

The transmitting device 222 may be configured to electronically transmit data signals to point of sale devices 108, acquiring financial institutions 114, or payment networks 116 that may be superimposed or otherwise encoded with transaction messages. The transmitting device 222 may be configured to electronically transmit data signals to acquiring financial institutions 114, verification processors 118, or point of sale devices 108 that are superimposed or otherwise encoded with hashed product identifiers, verification results, or notification data. The transmitting device 222 may also be configured to electronically transmit data signals to acquiring financial institutions 114, which may be superimposed or otherwise encoded with verification results.

### Process for Verifying Product Authenticity at a Point of Sale

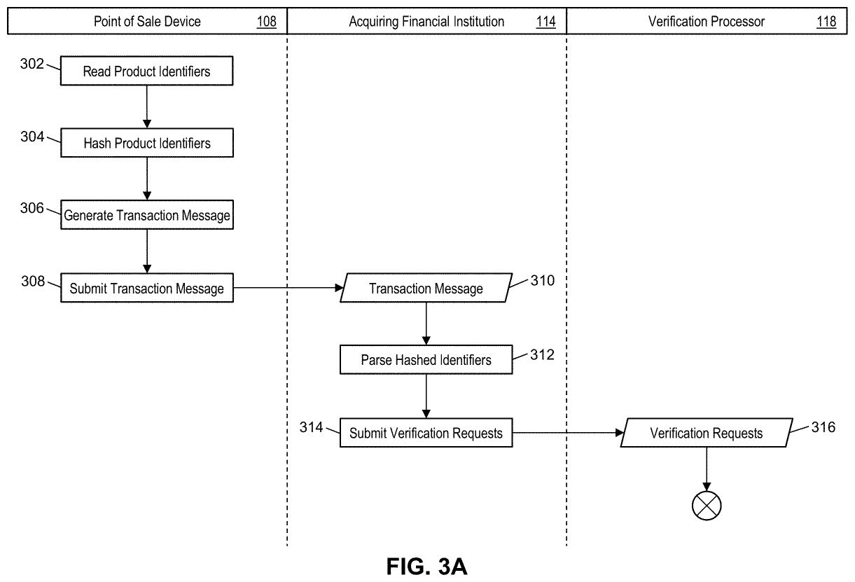

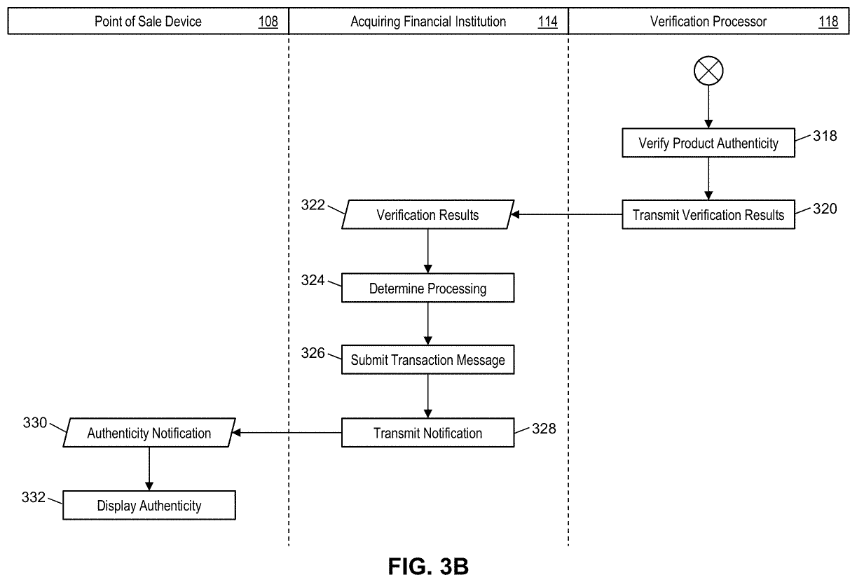

FIGS. 3A and 3B illustrates a process for the verification of the authenticity of one or more products being purchased at a point of sale using transaction messages in the system 100 illustrated in FIG. 1 and discussed above.

In step 302, the point of sale device 108 may read product identifiers from one or more products to be purchased by a consumer 110 using a suitable method, such as the reading of machine-readable codes displayed on the products that are encoded with the product identifier of the corresponding product. The product identifier may be unique to the product or may be otherwise associated with the product, such as a lot number for medication. In step 304, the point of sale device 108 may (e.g., via a generation module 216) hash the read product identifiers to generate a hashed product identifier for each product for which authenticity is to be verified. In some cases, the consumer 110 may indicate the products for which they would like the authenticity to be verified. In other cases, the products may be identified via one or more rules or criteria, which may be automatically identified by the point of sale device 108 upon reading of a product identifier. In step 306, the point of sale device 108 may (e.g., via a transaction processing module 220) generate a transaction message for a payment transaction for purchase of the products whose product identifiers were read in step 302. The transaction message may be specially formatted pursuant to one or more standards governing the interchange of financial transaction messages, and may include a plurality of data elements storing transaction data including one or more data elements that store the hashed product identifier(s).

In step 308, the point of sale device 108 may (e.g., via a transmitting device 222) electronically transmit the generated transaction message to an acquiring financial institution 114, such as via payment rails associated with a payment network 116. In step 310, the acquiring financial institution 114 may (e.g., via a receiving device 202) receive the transaction message from the point of sale device 108. In step 312, the acquiring financial institution 114 may (e.g., via a querying module 214) parse the hashed product identifier(s) for products whose authenticity is to be verified from the predetermined data element(s) in which they are stored, which may be identified via one or more bitmaps in the transaction message. In step 314, the acquiring financial institution 114 may (e.g., via a transmitting device 222) submit a verification request for each of the hashed product identifiers to the verification processor 118, such as using an application programming interface made available by the verification processor 118. In step 316, the verification processor 118 may (e.g., via a receiving device 202) receive the one or more verification requests, each of which may include a hashed product identifier parsed from the transaction message.

In step 318, the verification processor 118 may (e.g., via a validation module 218) perform a verification process for each verification request. The verification process may include identifying all blockchain data values stored in a provenance blockchain that include the hashed product identifier and determining if there is a proper chain of custody from manufacture of the product all the way through to possession by the merchant associated with the point of sale device 108. In some cases, a device identifier for the point of sale device 108 or merchant identifier may included in a verification request to ensure that the merchant involved in the transaction is the same merchant that accepted the product for sale in the provenance blockchain. The verification processor 118 may identify a result of the verification process for each hashed product identifier (e.g., success or failure) and, in step 320, may (e.g., via a transmitting device 222) electronically transmit the verification result for each verification request to the acquiring financial institution 114, such as via the application programming interface.

In step 322, the acquiring financial institution 114 may (e.g., via a receiving device 202) receive the verification result(s) from the verification processor 118. In step 324, the acquiring financial institution 114 may (e.g., via a transaction processing module 220) determine if the payment transaction is to be processed. The determination may be based on the verification results, where one or more failed verifications may result in the payment transaction being declined by the acquiring financial institution 114. In such an instance, an authorization response (e.g., as indicated by the message type indicator in a transaction message) may be returned to the point of sale device 108. In the example illustrated in FIG. 3B, the acquiring financial institution 114 may determine that all verification results were successful and may, in step 326, electronically transmit (e.g., via a transmitting device 222) the transaction message for the payment transaction to a payment network 116 or issuing financial institution 112 via payment rails for processing using traditional methods or systems. In some instances, the hashed product identifier(s) may be removed from the transaction message prior to forwarding by the acquiring financial institution 114.

In step 328, the acquiring financial institution 114 may (e.g., via a transmitting device 222) electronically transmit a notification message to the point of sale device 108. The notification message may indicate that the authentication of each of the applicable products was successful. In step 330, the point of sale device 108 may (e.g., via a receiving device 202) receive the notification message. In step 332, the notification message may be displayed to the consumer 110, which may ensure the consumer 110 that the products being purchased are genuine as a result of the successful verification of the authenticity using the provenance blockchain. The payment transaction may be processed and products given to the consumer 110 using traditional methods.

### Exemplary Method for Verifying Product Authenticity

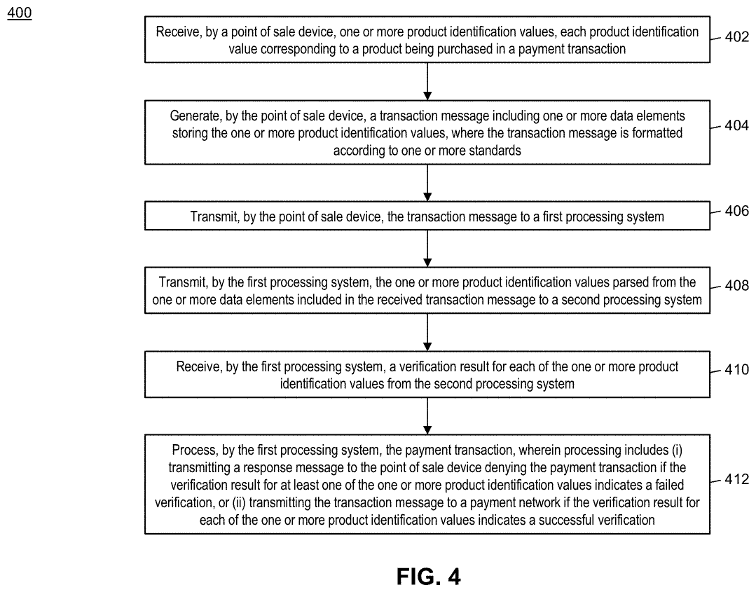

FIG. 4 illustrates a method 400 for verifying product authenticity at a point of sale through transaction messages.

In step 402, one or more product identification values may be received (e.g., via a receiving device 202) by a point of sale device (e.g., point of sale device 108), each product identification value corresponding to a product being purchased in a payment transaction. In step 404, a transaction message may be generated (e.g., via a generation module 216) by the point of sale device that includes one or more data elements storing the one or more product identification values, where the transaction message is formatted according to one or more standards. In step 406, the transaction message may be transmitted (e.g., via a transmitting device 222) to a first processing system (e.g., acquiring financial institution 114) by the point of sale device.

In step 408, the one or more product identification values parsed from the one or more data elements included in the received transaction message may be transmitted (e.g., via a transmitting device 222) by the first processing system to a second processing system (e.g., verification processor 118). In step 410, the first processing system may receive (e.g., via a receiving device 202) a verification result for each of the one or more product identification values from the second processing system. In step 412, the payment transaction may be processed (e.g., via a transaction processing module 220) by the first processing system, wherein processing includes (i) transmitting (e.g., via a transmitting device 222) a response message to the point of sale device denying the payment transaction if the verification result for at least one of the one or more product identification values indicates a failed verification, or (ii) transmitting the transaction message to a payment network (e.g., payment network 116) if the verification result for each of the one or more product identification values indicates a successful verification.

In one embodiment, the transaction message may be transmitted to the first processing system using payment rails. In some embodiments, the first processing system may be an acquiring financial institution system and the second processing system may be a third party processor system. In one embodiment, the one or more standards may include at least one of: ISO 8583 and ISO 20022. In some embodiments, the one or more data elements may be reserved for private use according to the one or more standards.

In one embodiment, the one or more product identification values may be transmitted to the second processing system using an application programming interface. In some embodiment, the method 400 may further include generating (e.g., via a generation module 216), by the point of sale device, a hash value for each of the one or more product identification values by applying a hashing algorithm to the product identification value, wherein the one or more data elements included in the transaction message stores the hash value for each of the one or more product identification values in place of the product identification value. In one embodiment, the method 400 may also include: receiving (e.g., via a receiving device 202), by the second processing system, the one or more product identification values from the first processing system; determining (e.g., via a validation module 218), by the second processing system, the verification result for each of the one or more product identification values based on inclusion of the product identification value in a block of a plurality of blocks comprising a blockchain, where a failed verification occurs if the product identification value is not included in any block of the plurality of blocks; and transmitting (e.g., via a transmitting device 222), by the second processing system, the verification result for each of the one or more product identification values to the first processing system.

### Computer System Architecture

FIG. 5 illustrates a computer system 500 in which embodiments of the present disclosure, or portions thereof, may be implemented as computer-readable code. For example, the point of sale device 108, acquiring financial institution 114, and verification processor 118 of FIG. 1 and the computing system 200 of FIG. 2 may be implemented in the computer system 500 using hardware, non-transitory computer readable media having instructions stored thereon, or a combination thereof and may be implemented in one or more computer systems or other processing systems. Hardware may embody modules and components used to implement the methods of FIGS. 3A, 3B, and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3A, 3B, and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods verifying product authenticity at a point of sale through transaction message. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for verifying product authenticity at a point of sale through transaction messages, comprising:
receiving, by a point of sale device, one or more product identification values, each product identification value corresponding to a product being purchased in a payment transaction;
generating, by the point of sale device, a transaction message including one or more data elements storing the one or more product identification values, where the transaction message is formatted according to one or more standards;
transmitting, by the point of sale device, the transaction message to a first processing system;
transmitting, by the first processing system, the one or more product identification values parsed from the one or more data elements included in the received transaction message to a second processing system;
receiving, by the first processing system, a verification result for each of the one or more product identification values from the second processing system; and
processing, by the first processing system, the payment transaction, wherein processing includes (i) transmitting a response message to the point of sale device denying the payment transaction if the verification result for at least one of the one or more product identification values indicates a failed verification, or (ii) transmitting the transaction message to a payment network if the verification result for each of the one or more product identification values indicates a successful verification.

2. The method of claim 1, wherein the transaction message is transmitted to the first processing system using payment rails.

3. The method of claim 1, wherein the first processing system is an acquiring financial institution system and the second processing system is a third party processor system.

4. The method of claim 1, wherein the one or more standards includes at least one of: ISO 8583 and ISO 20022.

5. The method of claim 1, wherein the one or more data elements are reserved for private use according to the one or more standards.

6. The method of claim 1, wherein the one or more product identification values are transmitted to the second processing system using an application programming interface.

7. The method of claim 1, further comprising:
generating, by the point of sale device, a hash value for each of the one or more product identification values by applying a hashing algorithm to the product identification value, wherein
the one or more data elements included in the transaction message stores the hash value for each of the one or more product identification values in place of the product identification value.

8. The method of claim 1, further comprising:
receiving, by the second processing system, the one or more product identification values from the first processing system;
determining, by the second processing system, the verification result for each of the one or more product identification values based on inclusion of the product identification value in a block of a plurality of blocks comprising a blockchain, where a failed verification occurs if the product identification value is not included in any block of the plurality of blocks; and
transmitting, by the second processing system, the verification result for each of the one or more product identification values to the first processing system.

9. A system for verifying product authenticity at a point of sale through transaction messages, comprising:
a point of sale device;
a first processing system; and
a second processing system, wherein
the point of sale device
receives one or more product identification values, each product identification value corresponding to a product being purchased in a payment transaction,
generates a transaction message including one or more data elements storing the one or more product identification values, where the transaction message is formatted according to one or more standards, and
transmits the transaction message to the first processing system, and the first processing system
transmits the one or more product identification values parsed from the one or more data elements included in the received transaction message to the second processing system;
receives a verification result for each of the one or more product identification values from the second processing system, and
processes the payment transaction, wherein processing includes (i) transmitting a response message to the point of sale device denying the payment transaction if the verification result for at least one of the one or more product identification values indicates a failed verification, or (ii) transmitting the transaction message to a payment network if the verification result for each of the one or more product identification values indicates a successful verification.

10. The system of claim 9, wherein the transaction message is transmitted to the first processing system using payment rails.

11. The system of claim 9, wherein the first processing system is an acquiring financial institution system and the second processing system is a third party processor system.

12. The system of claim 9, wherein the one or more standards includes at least one of: ISO 8583 and ISO 20022.

13. The system of claim 9, wherein the one or more data elements are reserved for private use according to the one or more standards.

14. The system of claim 9, wherein the one or more product identification values are transmitted to the second processing system using an application programming interface.

15. The system of claim 9, wherein
the point of sale device generates a hash value for each of the one or more product identification values by applying a hashing algorithm to the product identification value, and
the one or more data elements included in the transaction message stores the hash value for each of the one or more product identification values in place of the product identification value.

16. The system of claim 9, wherein the second processing system
receives the one or more product identification values from the first processing system,
determines the verification result for each of the one or more product identification values based on inclusion of the product identification value in a block of a plurality of blocks comprising a blockchain, where a failed verification occurs if the product identification value is not included in any block of the plurality of blocks, and
transmits the verification result for each of the one or more product identification values to the first processing system.
